(19) United States
(12) Patent Application Publication
(10) Pub. No.: US 2008/0149046 A1
(43) Pub. Date: Jun. 26, 2008

(54) Foot and Knee Protectors for an Animal

(76) Inventor: James Tsai, Chia-Yi City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/615,034

(22) Filed: Dec. 22, 2006

(51) Int. Cl. A01K 13/00

(52) U.S. Cl. 119/850

(57) ABSTRACT

A foot protector and a knee protector for an animal are provided. The protectors both comprise a main portion. The foot protector features a single opening whereas the knee protector features two openings. The main portion is made from a thermoplastic material and an elastic element is further provided for the openings. Thus, the foot protector and the knee protector can be elastically fitted on a foot of the animal.

### CROSS-REFERENCES TO RELATED APPLICATIONS

Not applicable.

### BACKGROUND OF THE INVENTION

1. Field of the Invention

The present invention relates to foot and knee protectors for an animal. In particular, the invention relates to foot and knee protectors for an animal or a pet in order to prevent injuries and protect from dirt.

2. Descriptions of the Related Art

Humans have domesticated many types of animals as pets for reasons such as company, security and labor. However, the environment built by humans may not be ideal and comfortable for the animals and pets, which may be accustomed to living in a more natural environment. For example, the temperatures of asphalt roads during noon in the summer are extremely high and are not suitable for animals for extended periods of time. Moreover, some pet keepers may bring their pets into danger without knowing so. For example, if a pet keeper jogs on the beach with his or her pet, the high temperature of the sands may chronically injure the foot of the pet. Furthermore, pets may take risks of injury during running and jumping in day-to-day activities.

As compared with human beings, animals are generally more resistant to pain. For example, some people may walk the dog on asphalt roads where we are not willing to walk barefoot thereon. While animals may be able to resist this pain, they may in fact suffer physical injuries due to this resistance. Moreover, animals or pets do not speak, rendering it difficult for them to express to humans their discomforts, such as stings and burns.

Many domestic animals also frequently confront dangers present in their duties. One of the most noteworthy examples is the environment in which police dogs work. Police dogs need to run on various terrains, where there may exist branches of trees, traps, metallic pieces, fire, and so on.

Because of all these situations, some protection items adapted for the feet or knees of animals have been manufactured on the market. However, most of these items pay more attention to ornamentation and aesthetics rather than protection. In addition, these protection items are usually made from textile or leather, which may be easily pierced or broken. Moreover, some of these foot protectors feature VELCRO® which may need several steps to equip on animals. It is fairly inconvenient for human to wear it into animal's feet; it is also very possible that the animals may readily take the protectors off by themselves.

Given problems the above, a novel protector for a foot or a knee of an animal needs to be developed in this field.

### SUMMARY OF THE INVENTION

The primary objective of this invention is to provide foot and knee protectors for an animal. The protectors facilitate wearability and comfort while being secured onto the foot by at least one elastic element. Although the protectors prevent the feet from being injured, they also protect any possible existing wounds from being exposed. The foot protector is especially designed to be thicker in certain areas as to protect the sole of the foot. The knee protector features two opposite openings and is utilized to protect the knee of the animal. The materials for manufacturing these protectors must pass certain material tests, including heat test, humidity test, and so on. These materials also must be suitable for wearability as well as durability for biting from the animal.

Another objective is to provide aesthetic and ornamental effects for the protectors in order to appeal to the customer and increase sales. Moreover, the protectors can also allow ventilation by forming apertures thereon.

To achieve the abovementioned objectives, the present invention discloses a foot protector for an animal. The foot protector comprises a main portion, a top portion, and a bottom portion, wherein the top portion and the bottom portion are oppositely connected to the main portion. The top portion is provided with an elastic element and the main portion and the bottom portion are made from a thermoplastic material, whereby the foot protector is adapted to be worn and elastically fitted on a foot of the animal.

The present invention further discloses a knee protector for an animal. The knee protector comprises a main portion, a first end portion, and a second end portion wherein the first end portion and the second end portion are oppositely connected to the main portion. The first end portion has a first opening while the second end portion has a second opening. The first end portion is provided with a first elastic element and the main portion is made from a thermoplastic material, whereby the knee protector is adapted to be worn and elastically fitted on a knee of the animal.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating the foot protector of the present invention as worn by an animal;

FIG. 2 is a schematic view illustrating an embodiment of the foot protector of the present invention;

FIG. 3 is a schematic view illustrating another embodiment of the foot protector of the present invention;

FIG. 4 is a schematic view illustrating the knee protector of the present invention as worn by an animal; and

FIG. 5 is a schematic view illustrating the knee protector of the present invention.

### DESCRIPTION OF THE PREFERRED EMBODIMENT

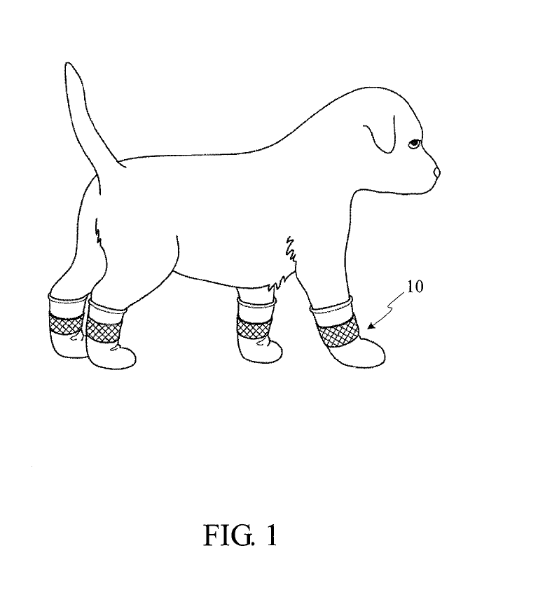

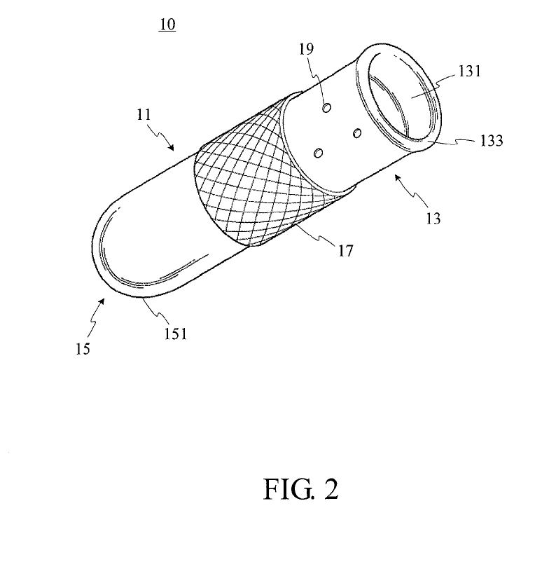

The foot protector 10 of the present invention as worn by an animal (for example, a dog) is illustrated in FIG. 1. As shown in FIG. 2, the foot protector 10 comprises a main portion 11, a top portion 13, and a bottom portion 15. The bottom portion 15 is opposite to the top portion 13 where both are connected to the main portion 11. In practice, the main portion 11, the top portion 13, and the bottom portion 15 are formed integrally.

In this embodiment, the main portion 11 and the bottom portion 15 can be made from a thermoplastic material. The top portion 13 has an opening 131 and is provided with an elastic element 133 thereon. Preferably, the elastic element 133 can be an elastic band to tighten the foot protector 10 on the foot of the animal. In association with the elastic element 133, the foot protector 10 is adapted to be worn and elastically fitted on the foot of the animal.

More specifically, the bottom portion 15 comprises a front end portion 151 fitted for the toes of the animal. Because the bottom portion 15 and the front end portion 151 are the portions in contact with the terrain, they will be more susceptible to damage when the foot protector 10 is equipped on an animal. Taking the durability into consideration, any one of the main portion 11, the top portion 13, and the bottom portion 15 could have a thicker portion (not shown in the figures) formed thereon, to locally strengthen the structure of the foot protector 10. In specific, the bottom portion 15 or the front end portion 151 may have a thickness greater than the thickness of the main portion 11. The thickness distribution on the foot protector 10 can be adjusted depending on which areas of the foot protector 10 are more susceptible to damage.

In addition, the foot protector 10 further comprises an outer layer 17 disposed on an outer surface of at least one of the main portion 11, the top portion 13, and the bottom portion 15. In practice, the outer layer 17 can be integrally, but not limited to be formed with onto an outer surface of the foot protector 10. More specifically, the outer layer 17 is made from the group selected from a textile, leather, or a combination. The outer layer 17 can have a distinctive pattern or design for ornamentation and also provide some preliminary protections for the foot protector 10.

The foot protector 10 can further comprise at least one aperture 19 formed on the main portion to improve the ventilation on the foot protector 10. Thus, the animal wearing the foot protector 10 of the present invention may feel more comfortable.

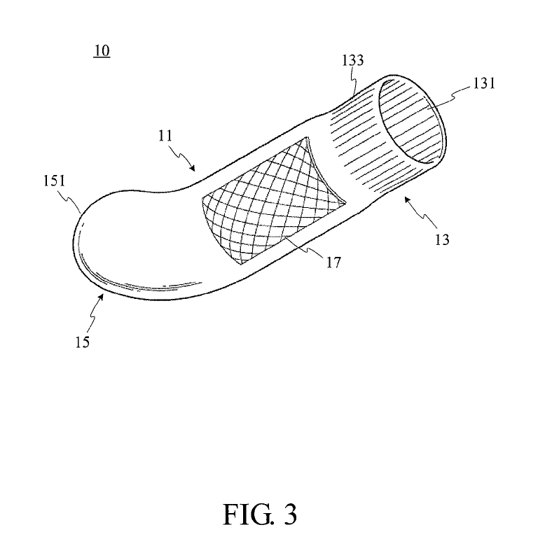

Another preferable embodiment is shown in FIG. 3. In this embodiment, the bottom portion 15 of the foot protector 10 has a shape for fitting the foot of the animal. The shape of the bottom portion 15 can be designed for different animals which is not limited herein. In FIG. 3, another embodiment of the elastic element 133 is further illustrated. The elastic element 133 possesses a plurality of stripes which can also tighten the foot protector 10 onto the foot of the animal. It is noted that the modifications and replacements based on the present invention by those skilled in the art should be included.

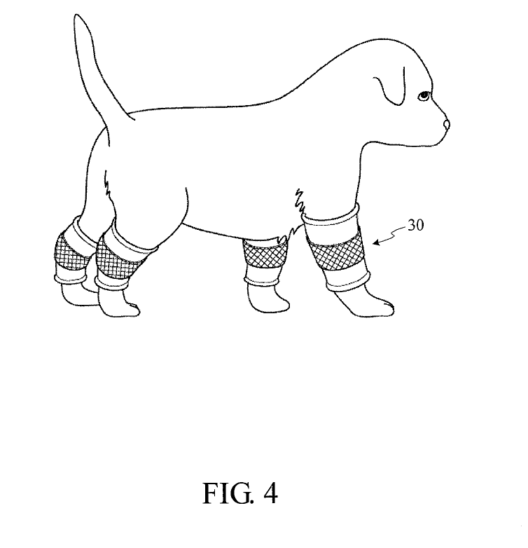

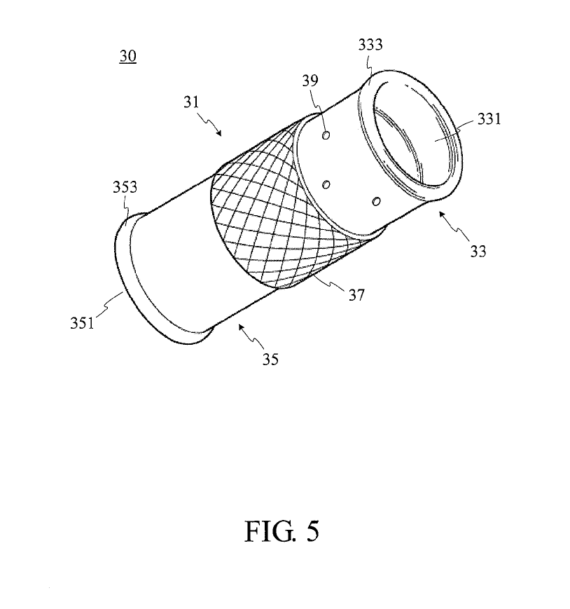

As shown in FIG. 4 and FIG. 5, the present invention also discloses a knee protector 30 which comprises a main portion 31, a first end portion 33, and a second end portion 35. The first end portion 33 has a first opening 331, and a second end portion 35 which is opposite to the first end portion 33 has a second opening 351. Both of the first end portion 33 and the second end portion 35 are connected to the main portion 31. Preferably, the first end portion 33 and the second end portion 35 are integrally formed with the main portion 31.

Similarly, the main portion 31 is made from a thermoplastic material, and a first elastic element 333 is provided on the first end portion 33, whereby the knee protector 30 is adapted to be worn and elastically fitted on a knee of the animal. Furthermore, a second elastic element 353 can be provided on the second end portion 35 if the knee protector 30 prefers to provide a relatively higher fastening effect on the both ends to prevent it from moving downward during use. In this embodiment, the first elastic element 333 and the second elastic element 353, which are respectively formed with the first end portion 33 and the second end portion 35, can be elastic bands or a plurality of stripes for tightening the knee protector 30 on the knee of the animal.

Like the above-mentioned foot protector 11, the knee protector 30 also has an outer layer 37 disposed on an outer surface of at least one of the main portion 31, the first end portion 33 and the second end portion 35. Preferably, the outer layer 37 which is made from textile, leather, or a combination, can be used to enhance the appearances or protecting abilities. Similarly, at least one aperture 39 can be formed on the main portion 31 for ventilation. Any of the main portion 31, the first end portion 33, and the second end portion 35 can have a thicker portion formed thereon to locally strengthen structure thereof. That is to say, the thicknesses distributed on the knee protector 30 can be partially adjusted to improve performance on protection.

It is noted that the outer layers 35, 37 can completely cover onto the foot protector 10 or the knee protector 30. Various patterns or designs can be made on the outer layers 35, 37 to provide an attractive appearance. Furthermore, the length of the foot protector 10 or the knee protector 30 is not limited. That is to say, the foot protector 10 may extend to cover the knee of the animal.

According to the abovementioned disclosures, the foot and knee protectors can be easily equipped with ornamental effects. Furthermore, the foot and knee protectors of the present invention can effectively protect the foot of the animal from injures and dirt.

The above disclosure is related to the detailed technical contents and inventive features thereof. Those skilled in this field may proceed with a variety of modifications and replacements based on the disclosures and suggestions of the invention as described without departing from the characteristics thereof. Although such modifications and replacements are not fully disclosed in the above descriptions, they have substantially been covered in the following claims as appended.

What is claimed is:

1. A foot protector for an animal, the foot protector comprising:
a main portion;
a top portion having an opening, the top portion being connected to the main portion and provided with an elastic element;
a bottom portion, being opposite to the top portion and connected to the main portion;
wherein the main portion and the bottom portion are made from a thermoplastic material, whereby the foot protector is adapted to be worn and elastically fitted on a foot of the animal.

2. The foot protector as claimed in claim 1, wherein the top portion, the main portion and the bottom portion are formed integrally.

3. The foot protector as claimed in claim 2, wherein the bottom portion comprises a front end portion fitted for toes of the animal.

4. The foot protector as claimed in claim 3, wherein the front end portion has a thickness greater than a thickness of the main portion.

5. The foot protector as claimed in claim 2, wherein the bottom portion has a thickness greater than a thickness of the main portion.

6. The foot protector as claimed in claim 1, further comprising an outer layer disposed on an outer surface of at least one of the top portion, the main portion and the bottom portion.

7. The foot protector as claimed in claim 6, wherein the outer layer is made from the group selected from a textile, leather, or the combination.

8. The foot protector as claimed in claim 1, further comprising at least one aperture formed on the main portion.

9. The foot protector as claimed in claim 1, wherein the elastic element is formed integrally with the top portion.

10. The foot protector as claimed in claim 1, wherein any of the top portion, main portion and bottom portion has a thicker portion formed thereon to locally strengthen structure thereof.

11. A knee protector for an animal, the knee protector comprising:
a main portion;
a first end portion having a first opening, the first end portion being connected to the main portion and provided with a first elastic element;
a second end portion having a second opening, the second end portion being opposite to the first end portion and connected to the main portion;
wherein the main portion is made from a thermoplastic material, whereby the knee protector is adapted to be worn and elastically fitted on a knee of the animal.

12. The knee protector as claimed in claim 11, wherein the second end portion is provided with a second elastic element.

13. The knee protector as claimed in claim 11, wherein the first end portion, the main portion and the second end portion are formed integrally.

14. The knee protector as claimed in claim 11, further comprising an outer layer disposed on an outer surface of at least one of the first end portion, the main portion and the second end portion.

15. The knee protector as claimed in claim 14, wherein the outer layer is made from the group selected from a textile, leather, or the combination.

16. The knee protector as claimed in claim 11, further comprising at least one aperture formed on the main portion.

17. The knee protector as claimed in claim 12, wherein the first elastic element is formed integrally with the first end portion and the second elastic element is formed integrally with the second end portion.

18. The knee protector as claimed in claim 11, wherein any of the first end portion, main portion and second end portion has a thicker portion formed thereon to locally strengthen structure thereof.
